(19) United States
(12) Patent Application Publication
(10) Pub. No.: US 2009/0154093 A1
(43) Pub. Date: Jun. 18, 2009

(54) Composition and Methods for Managing Heat Within an Information Handling System

(75) Inventors: Travis North, Pflugerville, TX (US); Michael Heatly, Round Rock, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/548,697

(22) Filed: Oct. 11, 2006

(51) Int. Cl. G06F 1/20; C09K 5/10

(52) U.S. Cl. 361/679.53; 252/75; 977/932

(57) ABSTRACT

An information handling system including a heat generating component positioned within the information handling system, a heat transfer surface in thermal communication with the heat generating component and a medium comprising water and gold thiolate nanoparticles, wherein the medium is in thermal communication with the heat transfer surface.

### BACKGROUND

1. Technical Field

The present disclosure relates generally to the field of information handling systems and, more particularly, to heat management.

2. Background Information

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A number of electronic components in an information handling system (IHS) including, but not limited to, the processor and drives, may generate large amounts of heat during their operation. In recent years, processor speeds have increased, and to generate the higher clock rates, more components such as transistors have been added to the processors. The transistors draw more power thereby leading to greater heat production by the processor. The increase in heat produced by the processor must be managed in order to keep IHS components within their safe operating temperatures. Several methods may be employed to transfer and dissipate heat generated by the internal components of an IHS, including the use of heat sinks and/or liquid cooling methods.

Recent advances in nanotechnology have given rise to an opportunity in heat transfer methods including liquid cooling. The addition of particles to fluids for the purpose of thermal conductivity has been a known practice in the development of liquid cooling techniques. Size, however, may pose a limitation on the ability of a particle to remain suspended in a given fluid, which in turn may have an affect on the conductivity of a fluid. For example, a microparticle with a diameter a thousand times greater than that of a nanoparticle, may tend to settle out of the fluid rather than remain suspended. In contrast, nanoparticles which measure nanometers in diameter are small enough to remain suspended in fluid and not settle. Furthermore, the electrical charges of the particles allow them to form a stable suspension in which the particles are evenly distributed throughout the fluid. This distribution may increase the overall surface area of the fluid, thus enhancing the thermal conductivity of the base fluid. An overall increase in the thermal conductivity of a fluid attributed to the addition of nanoparticles may be directly related to an overall increase in heat transfer.

### SUMMARY

The following presents a general summary of some of the many possible embodiments of this disclosure in order to provide a basic understanding of this disclosure. This summary is not an extensive overview of all embodiments of the disclosure. This summary is not intended to identify key or critical elements of the disclosure or to delineate or otherwise limit the scope of the claims. The following summary merely presents some concepts of the disclosure in a general form as a prelude to the more detailed description that follows.

In one embodiment, there is provided an information handling system which may include a heat generating component positioned within the information handling system. The system may further include a heat transfer surface in thermal communication with the heat generating component and a medium comprising water and gold thiolate nanoparticles, wherein the medium is in thermal communication with the heat transfer surface.

In another embodiment, there is provided a method for managing heat within an information handling system having an heat generating component in which the method may include providing a medium in thermal communication with the heat generating component, wherein the medium comprises water and gold thiolate nanoparticles.

In yet another embodiment, there is provided a heat transfer composition which may include water and gold thiolate nanoparticles dispersed within the water, wherein the gold thiolate nanoparticles are present in amount from about 0.1 to 25 percent by volume based on the total volume of the composition.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 presents a non-limiting illustration of an information handling system (IHS).

FIG. 2A presents an enlarged illustration of a heat transfer surface within an IHS of FIG. 1.

FIG. 2B presents an enlarged illustration of a nanoparticle as a component of a heat transfer composition.

### DETAILED DESCRIPTION

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

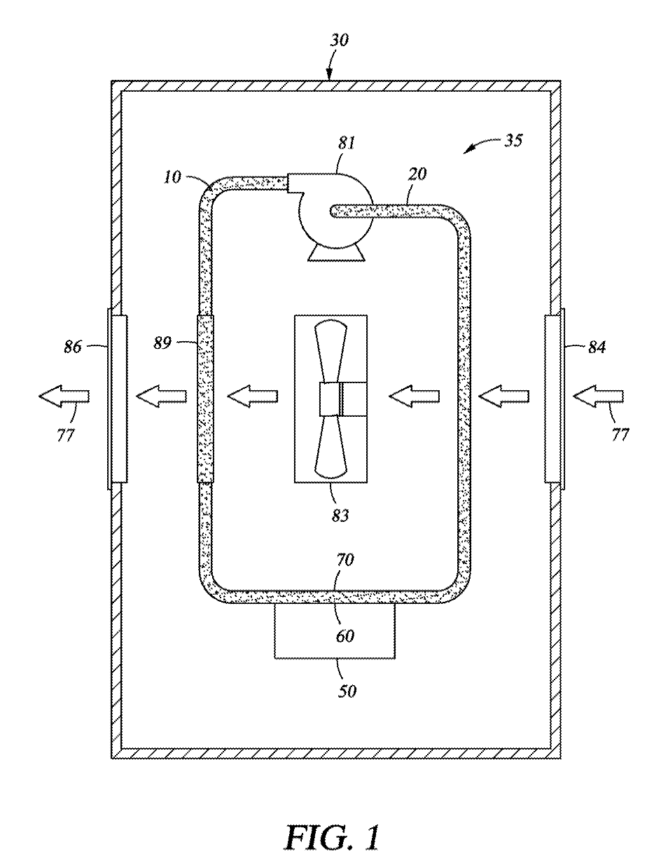

FIG. 1 depicts a non-limiting illustration of an information handling system (IHS) 30. As shown, a heat generating component 50 within an IHS 30 is in thermal communication with a heat transfer surface 60. The heat generating component 60 within the IHS 30 may take the form of any of a variety of devices, including a processor, drive, expansion card, chipset, power supply, any device or combination of devices within an IHS 30 with any heat generating capability. Also in thermal communication with the heat transfer surface 60 is medium 20 containing gold thiolate nanoparticles 10. The medium 20 may be a heat transfer medium comprising any material or substance that can transfer and/or absorb heat. For illustrative purposes, the medium 20 may comprise water, although it should be understood that the present disclosure may be applicable to any suitable liquid, gel, or gas.

Continuing with FIG. 1, an IHS 30 may comprise a cooling system 35 including a loop 70. The heat transfer surface 60 may be a plate or a portion of a loop or tube containing the medium 20. In one non-limiting embodiment, a medium 20 containing gold thiolate nanoparticles 10 is circulated within a closed loop 70 across a heat transfer surface 60 to absorb and/or transfer heat from the heat transfer surface 60 which is in thermal communication with a heat generating component 50 of the IHS. In another non-limiting embodiment, a medium 20 containing gold thiolate nanoparticles 10 is circulated within a closed loop 70 coupled to a pump 81 to circulate medium 20, whereby the medium 20 passes across a heat transfer surface 60 to absorb and/or transfer heat from the heat transfer surface 60 which is in thermal communication with a heat generating component 50 of the IHS. In yet another embodiment, a blower 83 may cause air flow 77 through air vent 84, past loop 70 at cooling zone 89, and out through air vent 86.

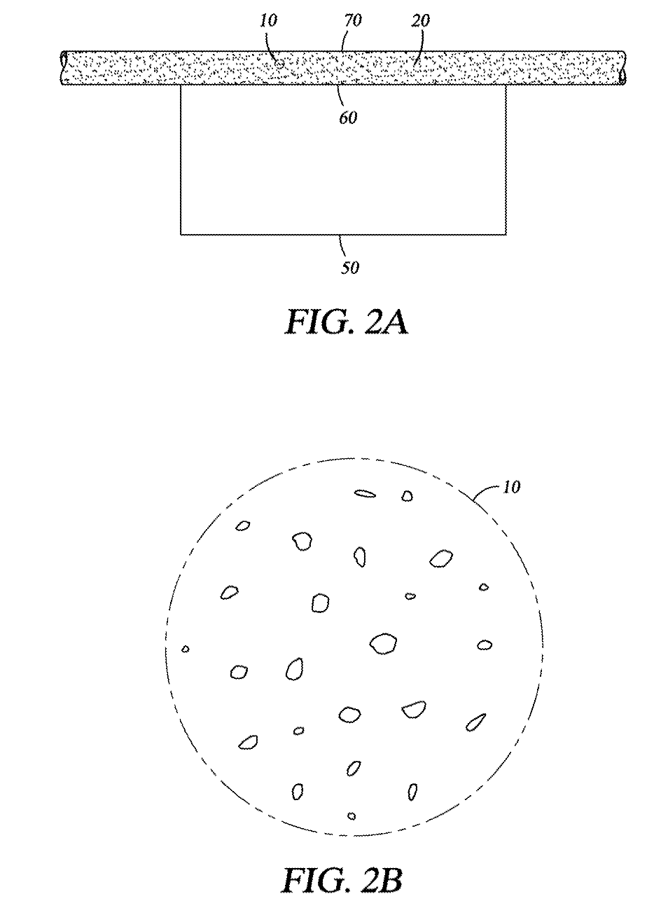

Shown in FIG. 2A is an enlarged illustration of a heat transfer surface 60 within an IHS of FIG. 1. As discussed above, a heat generating component 60 within an IHS 30 of FIG. 1 is in thermal communication with a heat transfer surface 60. The heat transfer surface 60 is also in thermal communication with medium 20 which comprises gold thiolate nanoparticles 10. As the medium 20 is flowing over the heat transfer surface 60, a thermal boundary layer is formed in which the energy from the heat generating component must travel through the medium 20 based upon conduction alone, as shown by Q=kAdt/dx. An overall increase in the conductivity will be directly related to an overall increase of heat transfer. By utilizing a small portion of nanoparticles, between 0.1 and 25% volume fraction, it is possible to increase heat transfer by 25%. The medium 20 including nanoparticles 10 shows significant enhancement over the base fluid or conventional water from 0.6 W/mK (water) to 0.75 W/mK (water+gold thiolate). This higher performance may, for a given flow rate, lower acoustics and allow for a decrease in size of the heat transfer surface 60. Assuming that the relationship between airflow and power is linear for a small range of revolutions per minute (RPM's), a decrease of ¼ of the RPM's of traditional liquid cooling systems may be predicted.

FIG. 2B is a view of an enlarged gold thiolate nanoparticle 10 from FIG. 1A. It should be understood that gold thiolate may be obtained from any suitable method utilizing any suitable apparatus, and that the particular method and apparatus for obtaining gold thiolate is not the focus of the present disclosure, nor is the present disclosure meant to be limited to any particular method or apparatus for obtaining gold thiolate. As merely a non-limiting example, gold thiolate suitable for use, may be generated through a chemical process in which the medium or water is combined with a catalyst. The resulting size of the gold thiolate nanoparticles 10 is governed by the amount of catalyst combined with the medium 20.

In one embodiment, within the closed loop 70 is passed a medium 20 comprising water with gold thiolate nanoparticles 10 on the scale of 10 to 60 nanometers whereby the gold thiolate nanoparticles 10 are present in amount from about 0.1 to 25 percent by volume based on the total volume of the medium 20. In another embodiment, there is provided in the closed loop 70 a medium 20 comprising water with gold thiolate nanoparticles 10 on the scale of 10 to 60 nanometers whereby the gold thiolate nanoparticles 10 are present in amount from about 1 to 25 percent by volume based on the total volume of the medium 20. In yet another embodiment, within the closed loop 70 is passed a medium 20 comprising water with gold thiolate nanoparticles 10 on the scale of 10 to 60 nanometers whereby the gold thiolate nanoparticles 10 are present in amount from about 1 to 4 percent by volume based on the total volume of the medium 20. It is understood that in alternative embodiments, other materials and/or metals may be contemplated or utilized. Furthermore, nanoparticles 10 having different sizes, any suitable particle size distribution, and being present in different percent by volume of media as described herein may be used.

While various embodiments have been shown and described, various modifications and substitutions may be made thereto without departing from the spirit and scope of the invention. Accordingly, it is to be understood that the present invention has been described by way of illustrations and not limitation.

What is claimed is:

1. An information handling system comprising:
a heat generating component positioned within the information handling system;
a heat transfer surface in thermal communication with the heat generating component; and
a medium comprising water and gold thiolate nanoparticles, wherein the medium is in thermal communication with the heat transfer surface.

2. The system of claim 1, wherein the heat generating component and the heat transfer surface are in direct contact.

3. The system of claim 1, further comprising a loop containing the medium, wherein a portion of the loop defines the heat transfer surface.

4. The system of claim 1, wherein the heat generating component is a processor.

5. The system of claim 4, further comprising a jacket wherein a portion of the jacket defines a heat transfer surface around the processor.

6. The system of claim 1, further comprising a pump to circulate the medium.

7. The system of claim 1, further comprising a blower positioned to force draft between the heat transfer surface and the heat generating component.

8. A method for managing heat within an information handling system having a heat generating component, the method comprising:
providing a medium in thermal communication with the heat generating component, wherein the medium comprises water and gold thiolate nanoparticles.

9. The method of claim 8, wherein the heat generating component is a processor.

10. The method of claim 8, further comprising circulating the medium proximate the heat generating component.

11. The method of claim 8, further comprising cooling the medium.

12. A heat transfer composition comprising;
water; and
gold thiolate nanoparticles dispersed within the water, wherein the gold thiolate nanoparticles are present in amount from about 0.1 to 25 percent by volume based on the total volume of the composition.

13. The composition of claim 12, wherein the nanoparticles are present in amount from about 1 to 4 percent by volume based on the total volume of the base fluid.

14. The composition of claim 12, wherein the nanoparticles are present in amount from about 1 to 25 percent by volume based on the total volume of the base fluid.

15. The composition of claim 12, wherein the nanoparticles are from 10 to 60 nanometers (nm) in size.

16. The composition of claim 12, wherein the nanoparticles are formed by contacting water with a catalyst.
